(19) United States
(12) Patent Application Publication
(10) Pub. No.: US 2004/0000327 A1
(43) Pub. Date: Jan. 1, 2004

(54) Apparatus and method for washing quartz parts, particularly for process equipment used in semiconductor industries

(76) Inventors: Fabio Somboli, Boltiere (IT); Raffaele Ninni, Treviglio (IT)

Correspondence Address: JENKENS & GILCHRIST, P.C., 3200 Fountain Place, 1445 Ross Avenue, Dallas, TX, 75202-2799, US

(21) Appl. No.: 10/183,583

(22) Filed: Jun. 26, 2002

(51) Int. Cl. B08B 5/04

(52) U.S. Cl. 134/21; 134/30; 134/31; 134/95.2; 134/103.2; 134/198

(57) ABSTRACT

An apparatus for washing quartz parts, particularly for process equipment used in semiconductor industries, comprising a process unit that is suitable to perform washing, a unit for managing washing and rinsing fluids, and a control unit, the units being mutually separate, the process unit comprising a bell-shaped element that is suitable to enclose hermetically the quartz parts to be washed, the quartz parts being inserted vertically in the bell-shaped element.

### BACKGROUND OF THE INVENTION

The present invention relates to an apparatus and a method for washing quartz parts, particularly for process equipment used in semiconductor industries.

As is known, process chambers inserted in furnaces used in the semiconductor industry to perform thermal processes such as APCVD (atmospheric pressure chemical vapor deposition) and LPCVD (low-pressure chemical vapor deposition) require preventive maintenance, i.e., cleaning. Substantially, after a certain number of processed wafers (oxidation/deposition), the process chamber must be removed from the furnace for cleaning. The purpose of the cleaning is the removal of residual deposits deposited on the walls of the process environment, i.e., on the walls of the process chamber.

As the wafers and the chambers are at the same temperature, the is succession of treatment cycles causes the residual deposits produced during the process to reach a certain critical level that subsequently compromises the degree of purity of the process. Accordingly, suitable limits have been set which cannot be exceeded, otherwise the degree of purity of the process is damaged.

Cleaning the process chamber allows to reuse said chamber, otherwise the chamber would have to be replaced every time said limits are exceeded.

Substantially, the chamber can be reused a certain number of times, so long as it is subjected to cleaning, and must then be replaced with a new chamber when a certain number of cleaning cycles is exceeded.

The cleaning process is usually performed by chemical etch (the acids typically used are hydrofluoric and nitric acid), but recently semiconductor industries have been testing a combination of acids with ultrasound.

The parts that make contact with acid solutions, are immersed therein or sprayed with them, must be rinsed and dried in a furnace for drying and degassing.

Typically, a quartz part immersed in the solution is wet completely and uniformly, but there is the risk of stagnation and a large amount of chemical substance is required.

When quartz parts are instead cleaned with sprays of chemical solution, a smaller amount of chemical solution is required, but uniformity is not always ensured. Probably, the best approach depends on the part to be rinsed. Due to cost reasons and to the degree of purity of the process, a spray cleaning method is usually preferred.

Known devices for cleaning quartz parts are substantially constituted by tanks of different sizes, in which the quartz tubes and the other parts are arranged. There are substantially two kinds of tank: one in which the quartz tube is inserted horizontally and the immersion process is then used, and one in which the quartz tube is inserted in a vertical tank and in this second case a spraying process is adopted.

To immerse very large parts, for example tubes for wafers of considerable size, it is necessary to have very large tanks, which as such are very bulky and require a large quantity of chemical solution for cleaning.

It has also been proposed to immerse the tube only partially, so as to be able to reduce the dimensions of the tanks, but this poses problems in terms of the rotation of the tube along its own axis in order to be able to clean the entire surface of the tube.

The horizontal version of the tank, moreover, poses problems in terms of rinsing and drying (fluid stagnation): to avoid this drawback it has been suggested to incline the tube, although this can entail more significant tube handling problems.

The vertical version of the tank usually requires spray cleaning. In this case, the quartz parts are placed in a process environment with spray nozzles that inject acid onto all the parts to be washed. Typically, this version of tank does not require moving the parts to be washed, but cleaning is not as uniform.

Substantially, therefore, there are the following problems of the prior art:

insufficient automation

difficulty in treating all the parts of the process chamber

process environments are not hermetic

difficulty in loading the quartz tube in the corresponding washing tank.

### SUMMARY OF THE INVENTION

The aim of the present invention is to provide an apparatus or a method for washing quartz parts, particularly for process equipment used in semiconductor industries, that allows a drastic reduction in acid consumption.

Within this aim, an object of the present invention is to provide an apparatus or method for washing quartz parts that allows to simplify the process environment, eliminating rotating parts and reducing contamination.

Another object of the present invention is to provide an apparatus or method for washing quartz parts that allows to perform the degassing step directly in the washing apparatus, reducing the duration of said washing operation.

Another object of the present invention is to provide an apparatus for washing quartz parts that has extremely compact dimensions with respect to known kinds of apparatus.

Another object of the present invention is to provide an apparatus for washing quartz parts that allows to clean, with the same apparatus, also small quartz parts without wasting washing mixture.

Another object of the present invention is to provide an apparatus or method for washing quartz parts that allows to recover efficiently and cleanly any unreacted used mixture.

Another object of the present invention is to provide an apparatus or method for washing quartz parts that is highly reliable, relatively simple to provide and at competitive costs.

This aim and these and other objects that will become better apparent hereinafter are achieved by an apparatus for washing quartz parts, particularly for process equipment used in semiconductor industries, comprising a process unit that is suitable to perform washing, a unit for managing washing and rinsing fluids, and a control unit, said units being mutually separate, said process unit comprising a bell-shaped element that is suitable to enclose hermetically said quartz parts to be washed, with said quartz parts inserted vertically in said bell-shaped element.

This aim, these objects and others are also achieved by a method for washing quartz parts, comprising the steps of:

introducing the quartz parts to be washed in a hermetic bell-shaped element;

cooling said quartz parts and introducing hot water in said bell-shaped element;

performing a chemical etching step with jets of vapor against said quartz parts;

rinsing said quartz parts;

drying said quartz parts.

### BRIEF DESCRIPTION OF THE DRAWINGS

Further characteristics and advantages of the apparatus and of the method according to the invention will become better apparent from the description of preferred but not exclusive embodiments thereof, illustrated only by way of non-limitative example in the accompanying drawings, wherein:

FIG. 1 is a schematic view of a first embodiment of the apparatus according to the present invention;

FIG. 2 is a schematic view of a second embodiment of the apparatus according to the present invention;

FIG. 3 is a schematic view of a variation of the second embodiment of the apparatus according to the present invention; and

FIG. 4 is a schematic view of another variation of the second embodiment of the apparatus according to the present invention.

### DESCRIPTION OF THE PREFERRED EMBODIMENTS

With reference to the figures, in which identical reference numerals designate identical elements, the apparatus for washing quartz parts according to the present invention has a modular structure, in which a first module is a process module, the second module is a fluid management module, and the third module is a control module.

The three modules are mutually connected by virtue of electrical cables and piping. The process module is the module in which the quartz tube is washed, while the remaining two modules can also be arranged physically elsewhere with respect to the process module.

The above cited modular structure is extremely practical, since in case of technical problems it is possible to replace a single module at a time instead of the entire structure.

The process module or cleaning module in which the affected parts are washed comprises a base element, conveniently constituted by a rotating platform 1, to which the part to be treated, for example a quartz tube 2 to be washed, is fixed.

The rotating platform is enclosed by a bell-shaped element 3, which is arranged in abutment against a base unit 4 in which the rotating base element, i.e., the platform 1, is accommodated.

Gasket means 5 are interposed between the bell-shaped element 3 and the base unit 4 and are suitable to maintain a hermetic seal between the bell-shaped element 3 and the base unit 4.

Conveniently, the bell-shaped element 3 and the base unit 4 are engaged by means of engagement elements 6.

The process module, generally designated by the reference numeral 10, therefore comprises the elements cited above.

Such module is conveniently accommodated in a suitable room 11 that is provided with a safety discharge opening 12 and an opening 13 for discharging the washing fluid, which is arranged below the base unit 4.

Conveniently, inside the bell-shaped element 3 there are a plurality of nozzles 14 that are arranged vertically and parallel to the axis of the quartz tube 2 that is accommodated within the bell-shaped element 3.

The apparatus according to the present invention therefore provides for a vertical arrangement of the quartz tube 2 to be washed, within the bell-shaped element 3, which can move upward and downward freely, so as to allow the removal and loading of the quartz tube 2 on the base element or rotating platform 1.

Additional nozzles can be arranged at the center of the rotating element or platform 1 and are designated by the reference numeral 15, but they are not monolithic with the platform 1.

The apparatus according to the present invention, in view of the hermetic seal ensured by the bell-shaped element 3 in abutment against the base unit 4, can be used for washing quartz parts both by spraying and by immersion, is i.e., by filling the bell-shaped element 3 with washing solution.

The washing solutions can be conveniently acid solutions for the first step and water for the rinsing step.

The step for rinsing the quartz parts is performed, as mentioned, by using water instead of the acid solution, and in this step also it is possible to choose between two methods: spraying or immersion.

Drying can be performed by spraying, by means of the nozzles 14 and 15, hot nitrogen, and the rotating platform 1 helps to ensure uniform cleaning and rinsing steps. Conveniently, the bell-shaped element 3 can be made of transparent material, so as to monitor the execution of the washing process.

The process module is further provided with a sensor, not shown, that measures resistivity during rinsing with water. This measurement can be used to evaluate the validity of the rinsing action.

Ultrasonic transducers 16 for generating ultrasound can be arranged below the rotating platform 1.

The temperature of the process environment is monitored constantly, so as to ensure that the apparatus operates in the most appropriate safety operating conditions.

The control module, designated by the reference numeral 20, instead comprises a control unit, such as for example a PLC, that is capable of controlling the washing process of the apparatus, and a user interface.

Finally, the fluid management module 30 comprises a unit that is capable of introducing washing solution, rinsing water, hot nitrogen for the subsequent drying treatment, in the bell-shaped element 3, in order to wash the quartz parts 2.

Accordingly, the apparatus according to the present invention allows to load in a vertical position the quartz parts to be washed and allows to choose, with a single apparatus, to perform washing by spraying or by immersion.

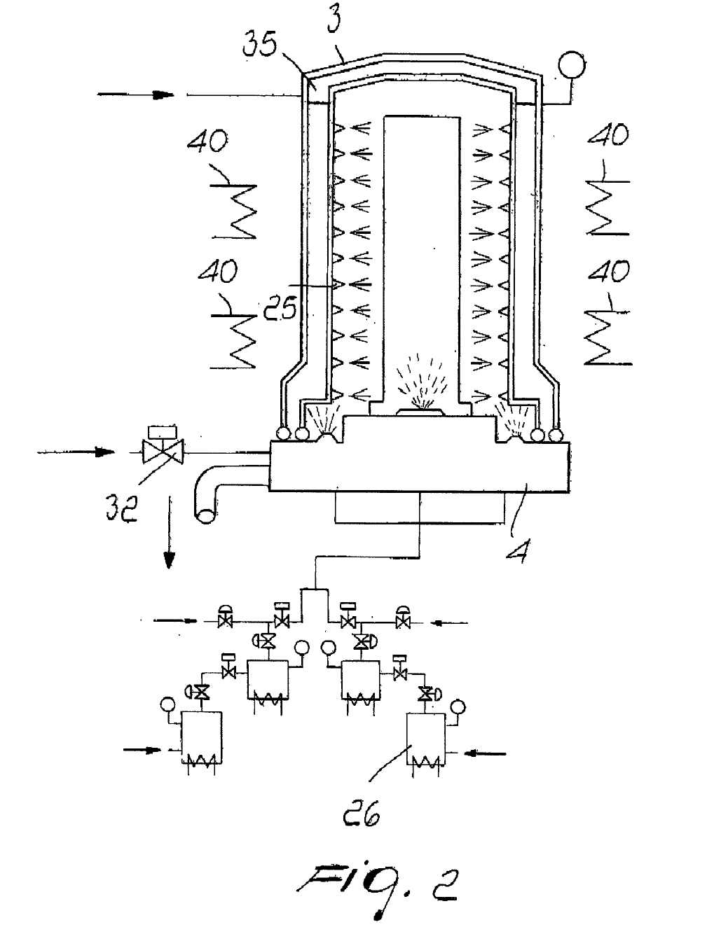

A second embodiment of the apparatus according to the present invention is shown in FIGS. 2 to 4.

In this embodiment, the bell-shaped element or tank 3 comprises a plurality of nozzles 25, which are integrated in an interspace 35 of the tank and are suitable to emit a rinsing fluid, such as for example water.

Moreover, the apparatus, shown for example in FIG. 2, has one or more nozzles 26 that are integrated in the base unit 4 and are suitable to diffuse vapor that is introduced in the bell-shaped element 3.

There is also a line for recovering the condensate for its subsequent reevaporation.

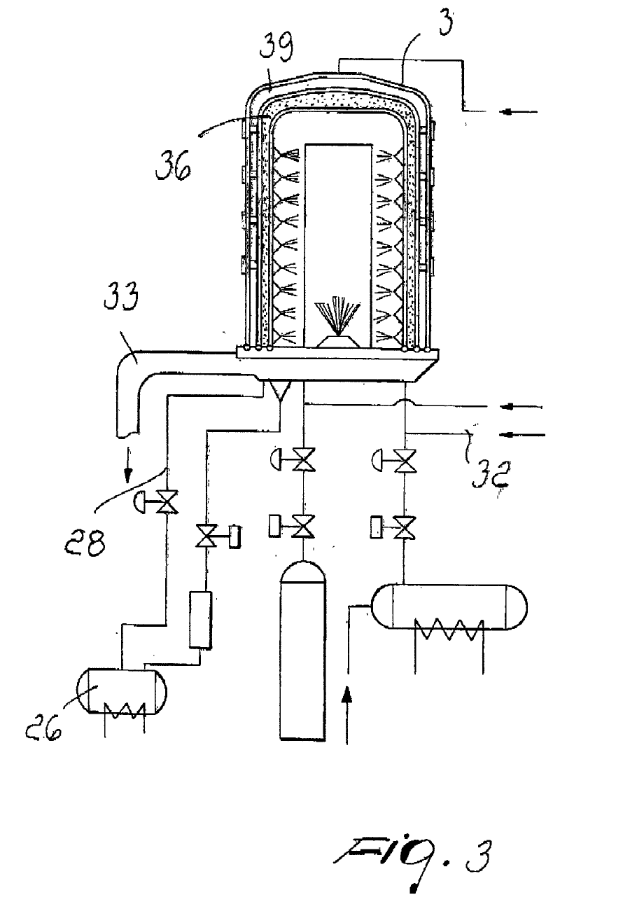

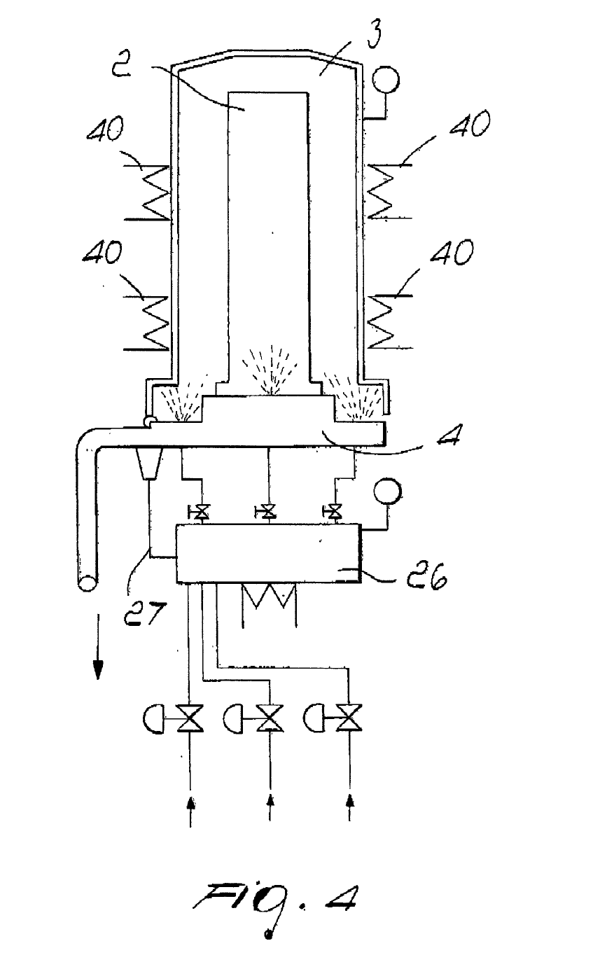

Said recovery line, designated by the reference numeral 27 in FIG. 2 and by the reference numeral 28 in FIG. 4, allows to convey the condensate in the first case (FIG. 4) to a heater 26 and in the second case (FIG. 3) to a separate circuit for condensate recovery.

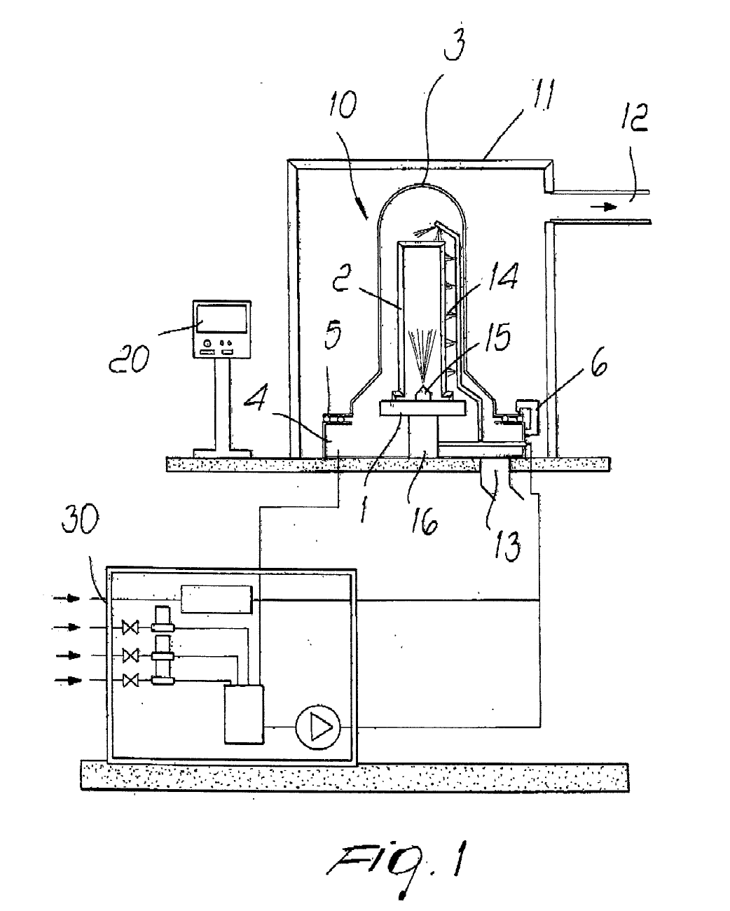

The embodiment shown in FIG. 2 differs, therefore, from the embodiment of FIG. 1 in that it does not have a rotating platform and has substantially vapor jets that exit from the base unit 4 instead of having a plurality of spray nozzles arranged vertically along the axis of the quartz tube to be washed.

In FIG. 2, as well as in FIG. 3, there are also additional heaters 40, which are arranged laterally to the bell-shaped element 3 and are meant to keep the quartz 2 and the process environment at different temperatures (since one seeks to condensate the vapor only on the quartz).

In FIG. 3 there are washing nozzles 25 that are integrated in the bell and are used for vapor-phase etching, and there is an external interspace for regulating the temperature of the bell with hot water.

Furthermore, FIG. 3 illustrates the presence of a line 32 for introducing rinsing fluid, for example water.

The line might also be present in the solution shown in FIG. 2, but as an alternative the rinsing fluid might be introduced by using one of the lines used to introduce the washing solution to be vaporized.

The embodiments shown in FIGS. 2, 3 and 4 each have a line 33 for forming a vacuum in the bell-shaped element 3.

FIG. 2 illustrates an embodiment in which the bell-shaped element 3 can be built so as to form an interspace 35 that can be filled by a rinsing fluid that can be ejected under pressure, by means of a pressurization gas, through the nozzles 25, so as to be directed against the quartz tube 2 to be rinsed. This interspace is also used for washing with a chemical solution in the vapor phase.

FIG. 3 instead illustrates another embodiment, in which the quartz tube 2 to be washed is inserted in the bell-shaped element 3, which is provided with an interspace 36 provided with integrated nozzles for vapor ejection. The bell-shaped element is further provided with an interspace 39 that is filled with water for regulating the temperature of the bell-shaped element, thus allowing to eliminate the heating elements 40 shown in FIGS. 2 and 4 (described hereinafter). The interspace 39 is arranged outside the interspace 36.

FIG. 4 instead illustrates a simplified variation of FIGS. 2 and 3, in which there are heating elements outside the bell-shaped element 3 and there is a condensate recovery line 27. The nozzles integrated in the base unit 4 are used to eject both the washing vapor and the rinsing fluid.

Substantially, the solution shown in the second embodiment of the present invention, with its variations, shown generally in FIGS. 2 to 4, allows to wash quartz parts by using vapor jets, with the quartz part always arranged vertically inside the bell-shaped element 3.

This provides a drastic reduction in the consumption of acid and also of washing water, saving money and providing greater respect for the environment.

Furthermore, the environment of the process is very linear because it has no rotating parts and no movements of the quartz 2 and/or of the nozzles, since the vapor diffuses everywhere easily and therefore rotation of the part to be washed is not required.

Furthermore, the process chamber is very safe, since it is hermetic and uses smaller quantities of acid than the embodiment of FIG. 1.

The apparatus according to the invention further allows to recover, in the second embodiment, efficiently and “cleanly” any unreacted used mixture, making it reevaporate.

This method allows to improve the current standards of cleanness, since the acid mixture is recycled in the vapor phase instead of in the liquid phase.

The operation of the apparatus according to the second embodiment of the present invention is as follows.

First of all, a different temperature is provided, between the bell-shaped element 3 and the quartz 2 to be washed, by injecting cold air on the quartz and hot water in the bell.

During the subsequent step, chemical etching with vapor/gas (vapor of the acid mixture) is performed, saturating the environment in which the quartz is placed (the quartz 2 is immersed in the vapor).

The vapor introduced in the process environment (inside the bell-shaped element 3) then condenses on the quarts, since said quartz is kept at a lower temperature than the walls of the chamber (bell-shaped element 3).

By controlling the pressure of the bell, the temperatures and flows, one can obtain different etching rates.

Once a film of condensate has been created and after waiting for an appropriate time, a subsequent rinsing step is performed.

The rinsing step is performed by means of deionized water, which in addition to rinsing the surface helps with a mechanical action to clean the surface of the quartz.

Once the step for spraying the water through the nozzles has ended, the water is drained and collected with condensed acid and the condensate is subsequently recovered.

This is followed by a drying step, in which the process environment is first saturated with hot nitrogen and then placed in vacuum, so as to achieve drying and degassing of the surface of the quartz 2.

At this point, the cycle can be repeated several times to obtain accurate washing.

The apparatus and the method according to the present invention allow to have very high washing efficiency with respect to known kinds of washing methods and devices.

In the case of the embodiment in which vapor is used for washing, the condensate produced by the vapor (very few ml of HF) etches the layer deposited on the quartz, while rinsing is performed subsequently with water. Then other vapor is recondensed and is followed by another rinsing step.

In practice it has been found that the apparatus and the method according to the invention fully achieve the intended aim and objects, since they allow to obtain a highly efficient washing of quartz parts, with reduced consumption of washing solution and with a far smaller area occupation than known kinds of solution.

The apparatus and the method thus conceived are susceptible of numerous modifications and variations; all the details may further be replaced with other technically equivalent elements.

In practice, the materials employed, so long as they are compatible with the specific used, as well as the contingent shapes and dimensions, may be any according to requirements and to the state of the art.

What is claimed is:

1. An apparatus for washing quartz parts, particularly for process equipment used in semiconductor industries, comprising a process unit that is suitable to perform washing, a unit for managing washing and rinsing fluids, and a control unit, said units being mutually separate, said process unit comprising a bell-shaped element that is suitable to enclose hermetically said quartz parts to be washed, with said quartz parts inserted vertically in said bell-shaped element.

2. The apparatus according to claim 1, wherein said bell-shaped element is rested on a base unit with sealing gaskets interposed.

3. The apparatus according to claim 2, wherein said bell-shaped element can move vertically in order to allow the loading and unloading of said quartz parts from a supporting platform.

4. The apparatus according to claim 3, wherein said supporting platform rotates.

5. The apparatus according to claim 1, wherein said bell-shaped element internally accommodates a supporting element for a plurality of vertically arranged nozzles that are parallel to the axis of said bell-shaped element and of said quartz parts accommodated within said bell-shaped element, in order to wash said quartz parts.

6. The apparatus according to claim 5, further comprising nozzles that are arranged centrally within said bell-shaped element.

7. The apparatus according to claim 2, wherein said base unit is provided with a plurality of nozzles for emitting vapor jets.

8. The apparatus according to claim 7, wherein said base unit has a line for forming a vacuum within said bell-shaped element.

9. The apparatus according to claim 7, further comprising a line for recovering the condensate formed inside said bell-shaped element.

10. The apparatus according to claim 7, further comprising, inside said bell-shaped element, in a vertical arrangement along the vertical extension of said bell-shaped element, a plurality of nozzles for the emission of vapor and/or fluid for washing.

11. The apparatus according to claim 10, wherein said nozzles are integrated in the wall of said bell-shaped element, said wall being formed with an interspace in which a washing solution and/or rinsing fluid is introduced.

12. The apparatus according to claim 7, wherein said bell-shaped element is provided with an interspace that is suitable to contain water in order to regulate the temperature of said bell-shaped element.

13. The apparatus according to claim 1, further comprising heating elements that are arranged outside said bell-shaped element.

14. The apparatus according to claim 1, wherein said quartz parts are supported by a fixed supporting platform.

15. A method for washing quartz parts, comprising the steps of:
introducing the quartz parts to be washed in a hermetic bell-shaped element;
cooling said quartz parts and introducing hot water in said bell-shaped element;
performing a step of chemical etching with jets of vapor against said quartz parts;
rinsing said quartz parts;
drying said quartz parts.

16. The method according to claim 15, wherein said step of performing chemical etching comprises the steps of:
using the vapor of an acid mixture;
introducing said vapor in said bell-shaped element and making said vapor condense on said quartz parts, said quartz parts being kept at a lower temperature than the walls of said bell-shaped element.

17. The method according to claim 16, wherein said step of performing chemical etching further comprises a step of controlling the pressure inside said bell-shaped element, the temperatures and the flows in order to obtain different chemical etching rates.

18. The method according to claim 15, wherein said step of rinsing said quartz parts is provided by jets of deionized water and is followed by the step for draining said deionized water.

19. The method according to claim 15, wherein said step of drying said quartz parts comprises the steps of:
saturating said bell-shaped element with hot nitrogen;
placing said bell-shaped element in vacuum in order to obtain drying and degassing of the surface of said quartz parts.
